(19) United States
(12) Patent Application Publication
(10) Pub. No.: US 2026/0196814 A1
(43) Pub. Date: Jul. 9, 2026

(54) JUNCTION BOX FACILITATING WIRING

(71) Applicant: Zhuhai Luminglite Lighting Tech Co., Ltd., Zhuhai (CN)

(72) Inventors: Li ZHOU, Zhuhai (CN); Kaihui TANG, Zhuhai (CN); An HOU, Zhuhai (CN); Huajun CHEN, Zhuhai (CN)

(21) Appl. No.: 19/054,714

(22) Filed: Feb. 14, 2025

(30) Foreign Application Priority Data
Jan. 7, 2025 (CN) 2025200305107

(51) Int. Cl. H02G 3/08; H02G 3/14

(52) U.S. Cl. CPC H02G 3/081; H02G 3/14

(57) ABSTRACT

The present disclosure relates to a junction box facilitating wiring. The junction box facilitating wiring comprises a box body, a first upper cover and a second upper cover, wherein the first upper cover and the second upper cover are both covered and connected to a top of the box body, and the second upper cover is rotatably connected to the first upper cover; a damping structure is provided at a rotatable joint between the first upper cover and the second upper cover, and the damping structure is configured to keep the second upper cover at a current position when no external force is applied. When wiring is needed, the user can flip open the second upper cover. After stopping the opening action, the damping structure enables the second upper cover to remain in its current position, allowing the user to perform the wiring operation.

### CROSS-REFERENCE TO RELATED APPLICATIONS

This application claims priority to Chinese Patent Application No. 202520030510.7, filed on Jan. 7, 2025, which is incorporated herein by reference in its entirety.

### TECHNICAL FIELD

The present disclosure relates to the technical field of junction boxes, in particular to a junction box facilitating wiring.

### BACKGROUND

A junction box is an electrical accessory used to protect and connect wires. Some existing junction boxes include a box body, a first upper cover and a second upper cover. The first upper cover is fixedly connected to the box body, and the second upper cover is rotatably connected to the first upper cover. When wiring is needed, the user can rotate and open the second upper cover to perform the wiring operation inside the junction box. However, the second upper cover is difficult to secure when opened and often naturally falls back toward the box body, interfering with the user's wiring operation and making it inconvenient for the user to wire.

### SUMMARY

To overcome the shortcomings of the prior art, the objective of the present disclosure is to provide a junction box facilitating wiring, making it easier for users to perform wiring operations without the second upper cover naturally falling back and interfering with the wiring.

To solve the above problems, the technical solution adopted by the present disclosure is as follows: a junction box facilitating wiring, comprising a box body, a first upper cover and a second upper cover, wherein the first upper cover and the second upper cover are both covered and connected to a top of the box body, and the second upper cover is rotatably connected to the first upper cover; and a damping structure is provided at a rotatable joint between the first upper cover and the second upper cover, and the damping structure is configured to keep the second upper cover at a current position when no external force is applied.

Compared with the prior art, the beneficial effects of the present disclosure are as follows: according to the junction box, a damping structure is provided at a rotatable joint between the first upper cover and the second upper cover. When wiring is needed, the user can flip open the second upper cover. After stopping the opening action, the damping structure enables the second upper cover to remain in its current position, allowing the user to perform the wiring operation. Therefore, the second upper cover of this junction box, which facilitates wiring, can be opened to different angles and maintained in the current position, facilitating wiring for the user and preventing the second upper cover from naturally falling back and interfering with the wiring process.

According to the aforementioned junction box facilitating wiring, the first upper cover is provided with an adapter groove, the second upper cover is provided with an adapter protrusion, the adapter protrusion is rotatably connected in the adapter groove, and the damping structure is provided on an inner wall of the adapter groove and/or an outer wall of the adapter protrusion.

According to the aforementioned junction box facilitating wiring, the damping structure comprises a first protrusion and a second protrusion, the first protrusion protrudes from the inner wall of the adapter groove and is in contact with the outer wall of the adapter protrusion, and the second protrusion protrudes from the outer wall of the adapter protrusion and is in contact with the inner wall of the adapter groove.

According to the aforementioned junction box facilitating wiring, the outer walls of both the first protrusion and the second protrusion are curved surfaces.

According to the aforementioned junction box facilitating wiring, the outer walls of both the first protrusion and the second protrusion are rough surfaces.

According to the aforementioned junction box facilitating wiring, both the inner wall of the adapter groove and the outer wall of the adapter protrusion are curved surfaces.

According to the aforementioned junction box facilitating wiring, the adapter protrusion and the box body are connected to each other via a rotating shaft screw.

According to the aforementioned junction box facilitating wiring, a side portion of the box body is provided with a first clamping structure, a side portion of the second upper cover is provided with a second clamping structure, and the first clamping structure is arranged to be clamped with the second clamping structure.

According to the aforementioned junction box facilitating wiring, a handle is provided on a side of the second upper cover close to the second clamping structure.

According to the aforementioned junction box facilitating wiring, an inner wall of the second upper cover is provided with an elastic piece, and when the second upper cover covers the top of the box body, the elastic piece abuts against an inner side wall of the box body.

The present disclosure will be further described in detail below in conjunction with the accompanying drawings and specific embodiments.

### BRIEF DESCRIPTION OF THE DRAWINGS

FIG. 1 is a side view of a junction box after a side cover is hidden according to an embodiment of the present disclosure;

FIG. 2 is a schematic structural diagram of a first upper cover according to an embodiment of the present disclosure;

FIG. 3 is a schematic structural diagram of a second upper cover according to an embodiment of the present disclosure.

### DETAILED DESCRIPTION OF THE EMBODIMENTS

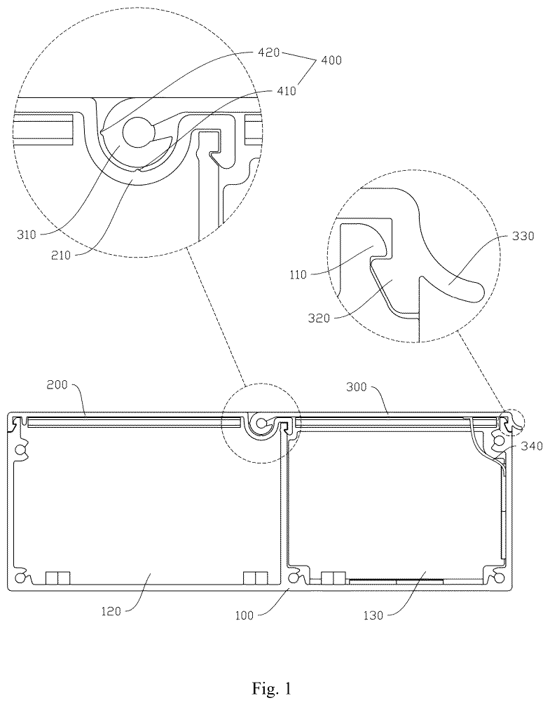

Embodiments of the present disclosure are described in detail below. Referring to FIG. 1 to FIG. 3, the embodiment of the present disclosure provides a junction box facilitating wiring, comprising a box body 100, a first upper cover 200 and a second upper cover 300. Referring to FIG. 1, the box body 100 is provided with a first cavity 120 and a second cavity 130, the first cavity 120 and the second cavity 130 are both provided with top openings, the first upper cover 200 and the second upper cover 300 are both covered and connected to a top of the box body 100, the first upper cover 200 is fixedly connected to the top of the box body 100 and seals the top opening of the first cavity 120, and the second upper cover 300 is rotatably connected to the first upper cover 200 and can close the top opening of the second cavity 130. A damping structure 400 is provided at a rotatable joint between the first upper cover 200 and the second upper cover 300, and the damping structure 400 is configured to keep the second upper cover 300 at a current position when no external force is applied. When wiring is needed, the user can flip open the second upper cover 300 to expose the top opening of the second cavity 130. After opening the second upper cover 300 to a certain position and stopping the opening action, the damping structure 400 enables the second upper cover 300 to remain in its current position without naturally falling back. At this point, the user can proceed with the wiring operation. Therefore, the second upper cover 300 of this junction box can be opened to different angles and maintained in the current position, facilitating wiring for the user and preventing the second upper cover 300 from naturally falling back and interfering with the wiring process.

Further, the first upper cover 200 is provided with an adapter groove 210, the second upper cover 300 is provided with an adapter protrusion 310, and the adapter protrusion 310 is rotatably connected in the adapter groove 210, allowing the second upper cover 300 to rotate and open relative to the first upper cover 200. Further, both the inner wall of the adapter groove 210 and the outer wall of the adapter protrusion 310 are curved surfaces, more specifically circular arc surfaces. The adapter groove 210 and the adapter protrusion 310 have a certain length in the direction of the rotating shaft, facilitating smoother rotation of the second upper cover 300 relative to the first upper cover 200. Further, the first upper cover 200 is snap-fitted to the box body 100, and the adapter protrusion 310 is connected to the box body 100 via a rotating shaft screw. Specifically, the box body 100 comprises a main body portion and a side cover the side cover is hidden in FIG. 1. The rotating shaft screw includes a threaded segment and a smooth shaft segment. The threaded segment is threaded into the adapter protrusion 310, and the smooth shaft segment is rotatably connected to the side cover. This design not only integrates the first upper cover 200, the second upper cover 300 and the box body 100 into one unit but also allows the second upper cover 300 to rotate and open smoothly. Further, after the rotating shaft screw is screwed into the adapter protrusion 310 and the box body 100, the segment located inside the side cover of the box body 100 is a smooth shaft without threads. Therefore, when rotating to open or close the second upper cover 300, the rotating shaft screw will rotate together with the second upper cover 300 relative to the first upper cover 200 and the box body 100, preventing the rotating shaft screw from loosening, thus ensuring that the second upper cover 300 remains integrated with the box body 100.

Further, a side portion of the box body 100 is provided with a first clamping structure 110, a side portion of the second upper cover 300 is provided with a second clamping structure 320, and the first clamping structure 110 is arranged to be clamped with the second clamping structure 320. During transportation and after the wiring is completed, it is necessary to reattach the second upper cover 300 to the box body 100. At this point, the second upper cover 300 and the box body 100 are clamped together through the first clamping structure 110 and the second clamping structure 320, achieving the closure and fixation of the second upper cover 300. Specifically, both the first clamping structure 110 and the second clamping structure 320 are hooks, and the two hooks interlock to establish the connection. Further, a handle 330 is provided on a side of the second upper cover 300 close to the second clamping structure 320, and the handle 330 protrudes outward from the side of the second upper cover 300. When it is necessary to open the second upper cover 300, the user can apply force to the handle 330, pulling the handle 330 outward, causing the second clamping structure 320 to disengage from the first clamping structure 110. After releasing the restraint between the second upper cover 300 and the box body 100, the second upper cover 300 can be rotated to open. Further, an inner wall of the second upper cover 300 is provided with an elastic piece 340, and when the second upper cover 300 covers the top of the box body 100, the elastic piece 340 abuts against an inner side wall of the box body 100. The elastic piece 340 is a structure capable of elastic deformation. When the second upper cover 300 is rotated to open, the elastic piece 340 is not under stress and is in its natural extended state, with its free end protruding from the side of the second upper cover 300. When the second upper cover 300 is rotated to close, the elastic piece 340 is accommodated in the box body 100, and its free end will abut against the side wall of the box body 100, thereby achieving a locking position between the second upper cover 300 and the box body 100 and further enhancing the fixation effect between the second upper cover 300 and the box body 100. Of course, in some embodiments, the elastic piece 340 can also be installed on the side wall of the box body 100. However, when the elastic piece 340 is installed on the second upper cover 300, elastic piece 340 will also move away from the box body 100 when the second upper cover 300 is rotated to open, greatly minimizing the interference of the elastic piece 340 with the user's wiring operations inside the box body 100.

Further, in some embodiments, the inner wall surface of the adapter groove 210 and the outer wall surface of the adapter protrusion 310 can be designed as rough surfaces, for example, by applying a layer of uneven structural coating, which serves as a damping structure 400 to increase the frictional resistance between the adapter groove 210 and the adapter protrusion 310. When force is applied to rotate the second upper cover 300, it can overcome this frictional resistance, allowing the second upper cover 300 to rotate smoothly. Upon removal of the external force, the second upper cover 300 can remain in its current position due to the frictional resistance between the adapter groove 210 and the adapter protrusion 310. In some embodiments, tiny protrusions can also be arranged on the inner wall of the adapter groove 210 or the outer wall of the adapter protrusion 310. These tiny protrusions are designed to provide a locking effect and increase friction, ensuring that the second upper cover 300 stays in its current position.

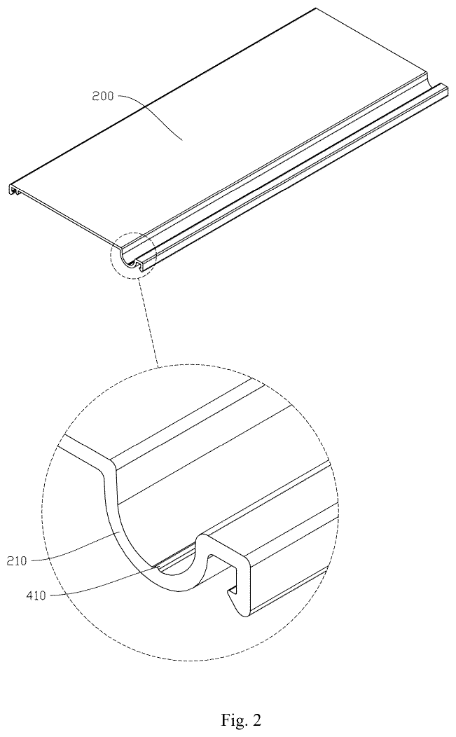

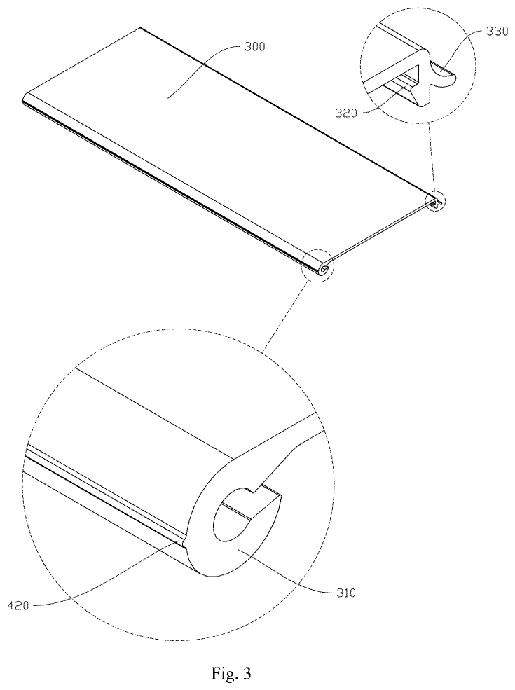

In some other embodiments, the damping structure 400 comprises a first protrusion 410 and a second protrusion 420, the first protrusion 410 protrudes from the inner wall of the adapter groove 210 and is in contact with the outer wall of the adapter protrusion 310, and the second protrusion 420 protrudes from the outer wall of the adapter protrusion 310 and is in contact with the inner wall of the adapter groove 210. The first protrusion 410 and the second protrusion 420 can be located at different positions to provide a locking effect and increase friction, thereby better enabling the second upper cover 300 to remain in its current position. It should be noted that both the first protrusion 410 and the second protrusion 420 are strip-shaped tiny protrusions. Specifically, refer to FIG. 2 and FIG. 3 for details; the strip-shaped tiny protrusions provide locking and friction. The protrusion height of these tiny protrusions is extremely low, so even with their presence, the adapter protrusion 310 and the adapter groove 210 can still maintain a rotatable connection. It should also be noted that although there is a gap between the adapter protrusion 310 and the adapter groove 210 in FIG. 1, and there is also a certain gap between the first clamping structure 110 and the second clamping structure 320, these gaps are only shown in the drawings to distinguish between different structures. In actual products, these gaps are very small and can be neglected. Further, the outer surfaces of both the first protrusion 410 and the second protrusion 420 are curved surfaces. When the second upper cover 300 rotates relative to the first upper cover 200, the first protrusion 410 will slide relatively against the outer wall of the adapter protrusion 310, and the second protrusion 420 will slide relatively against the inner wall of the adapter groove 210. The curved surface design allows for smoother sliding without causing scratches. Additionally, the outer surfaces of the first protrusion 410 and the second protrusion 420 are rough surfaces to increase friction and enhance the damping effect.

It should be noted that, in the description of the present disclosure, any references to orientation, such as “up”, “down”, “front”, “back”, “left”, “right”, etc., are based on the orientation or positional relationships depicted in the accompanying drawings. These references are solely for the convenience of describing the present disclosure and simplifying the description. They do not indicate or imply that the device or element referred must have a specific orientation, be constructed or operated in a particular orientation, and should not be construed as a limitation of the present disclosure.

In the description of the present disclosure, “a plurality of” shall refer to one or more, “multiple” shall refer to two or more, and expressions such as “more than,” “less than,” “exceed,” etc., shall be understood as excluding the stated number. Expressions such as “above,” “below,” “within,” etc., shall be understood as including the stated number. If references to “first” or “second” are made, they are merely for the purpose of distinguishing technical features, and should not be understood to indicate or imply relative importance, or implicitly specify the number of technical features being referred to, or imply any order of precedence among the technical features.

In the description of the present disclosure, unless otherwise explicitly limited, words such as “provided with”, “install”, and “connect” should be understood in a broad sense. Those skilled in the art can reasonably determine the specific meaning of the above words in the present disclosure in combination with the specific content of the technical solution.

The above-mentioned embodiments are only preferred embodiments of the present disclosure and cannot be used to limit the scope of protection of the present disclosure. Any non-substantive changes and substitutions made by those skilled in the art on the basis of the present disclosure shall belong to the scope of protection claimed by the present disclosure.

What is claimed is:

1. A junction box facilitating wiring, comprising a box body, a first upper cover and a second upper cover, wherein the first upper cover and the second upper cover are both covered and connected to a top of the box body, and the second upper cover is rotatably connected to the first upper cover; and a damping structure is provided at a rotatable joint between the first upper cover and the second upper cover, and the damping structure is configured to keep the second upper cover at a current position when no external force is applied.

2. The junction box facilitating wiring according to claim 1, wherein the first upper cover is provided with an adapter groove, the second upper cover is provided with an adapter protrusion, the adapter protrusion is rotatably connected in the adapter groove, and the damping structure is provided on an inner wall of the adapter groove and/or an outer wall of the adapter protrusion.

3. The junction box facilitating wiring according to claim 2, wherein the damping structure comprises a first protrusion and a second protrusion, the first protrusion protrudes from the inner wall of the adapter groove and is in contact with the outer wall of the adapter protrusion, and the second protrusion protrudes from the outer wall of the adapter protrusion and is in contact with the inner wall of the adapter groove.

4. The junction box facilitating wiring according to claim 3, wherein the outer walls of both the first protrusion and the second protrusion are curved surfaces.

5. The junction box facilitating wiring according to claim 3, wherein the outer walls of both the first protrusion and the second protrusion are rough surfaces.

6. The junction box facilitating wiring according to claim 2, wherein both the inner wall of the adapter groove and the outer wall of the adapter protrusion are curved surfaces.

7. The junction box facilitating wiring according to claim 2, wherein the adapter protrusion and the box body are connected to each other via a rotating shaft screw.

8. The junction box facilitating wiring according to claim 1, wherein a side portion of the box body is provided with a first clamping structure, a side portion of the second upper cover is provided with a second clamping structure, and the first clamping structure is arranged to be clamped with the second clamping structure.

9. The junction box facilitating wiring according to claim 8, wherein a handle is provided on a side of the second upper cover close to the second clamping structure.

10. The junction box facilitating wiring according to claim 1, wherein an inner wall of the second upper cover is provided with an elastic piece, and when the second upper cover covers the top of the box body, the elastic piece abuts against an inner side wall of the box body.
